(19) United States
(12) Patent Application Publication
(10) Pub. No.: US 2014/0191981 A1
(43) Pub. Date: Jul. 10, 2014

(54) SYSTEM AND METHOD TO DISPLAY CONTEXTUAL INFORMATION ON A HANDHELD DEVICE HAVING A SECONDARY AMBIENT DISPLAY

(71) Applicant: QUALCOMM MEMS TECHNOLOGIES, INC., San Diego, CA (US)

(72) Inventors: Vaidyanathan Pallavur Ramasarma, San Diego, CA (US); Mithran Cheriyan Mathew, Mountain View, CA (US)

(73) Assignee: QUALCOMM MEMS TECHNOLOGIES, INC., San Diego, CA (US)

(21) Appl. No.: 13/829,192

(22) Filed: Mar. 14, 2013

Related U.S. Application Data
(60) Provisional application No. 61/748,862, filed on Jan. 4, 2013.

(51) Int. Cl. G09G 5/00

(52) U.S. Cl. CPC G09G 5/003
USPC 345/173; 345/501

(57) ABSTRACT

This disclosure provides systems, methods and apparatus, including computer programs encoded on computer storage media, for controlling a display device that includes a first display and a second display. In one aspect, one or more sets of content may be generated or provided by one or more applications. Content may be prioritized within the sets of content or among the sets of content or both. Information pertaining to at least a portion of at least one of the sets of content generated or provided by at least one of the applications may be rendered to one or more of a plurality of regions of the second display according to a result of the prioritizing such that each of the at least one of the applications or content types associated therewith is mapped to a different one of the plurality of regions of the second display.

### CROSS-REFERENCE TO RELATED APPLICATION

This application claims benefit under 35 U.S.C. §119(e) to U.S. Provisional Patent Application No. 61/748,862, titled “DISPLAY DEVICES HAVING A PRIMARY DISPLAY AND A SECONDARY DISPLAY,” filed Jan. 4, 2013 (Attorney Docket Number QUALP182P1US/124423P1), which is incorporated by reference herein in its entirety and for all purposes.

### TECHNICAL FIELD

This disclosure relates to display systems and devices, and in particular to devices having secondary displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Many handheld display devices such as smartphones have single displays. These displays are often liquid crystal displays (LCDs), or “emissive displays,” such as organic light emitting displays (OLEDs).

Some handheld display devices have two displays. When information on the secondary display of handheld display devices is updated, these updates are often performed such that the entire secondary display is updated. The entire secondary display may be updated regardless of the amount of information that is updated or whether the updated information is of particular interest to the users. As a result, power is consumed to update the entire secondary display each time an update to the secondary display is performed.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus such as a handheld display device that includes a first display, a second display, and a control system. The control system or external server or both may be configured to identify or obtain one or more sets of content generated or provided by one or more applications. The control system or the external server or both may prioritize content within the sets of content or prioritize content among the sets of content or both. The control system or the external server or both may render information pertaining to at least a portion of at least one of the sets of content generated or provided by at least one of the applications to one or more of a plurality of regions of the second display according to a result of the prioritizing such that each of the at least one of the applications or content types associated therewith is mapped to a different one of the plurality of regions of the second display. The prioritizing may be performed based, at least in part, upon historical information pertaining to feedback that has been received with respect to information that has previously been rendered to at least one of the plurality of regions of the second display.

In some implementations, the historical information may indicate whether feedback has been received with respect to the information that has previously been rendered to the plurality of regions of the second display. The historical information also may indicate further characteristics of the previously received feedback.

In some implementations, the characteristics of the feedback may further indicate one or more of: a recency with which the feedback has been obtained with respect to one of the plurality of regions of the second display, an amount of time that has lapsed between the rendering of the information to the one of the plurality of regions of the second display and a time that the feedback with respect to the information that has been rendered to the one of the plurality of regions of the second display has been received, an amount of time spent by a user viewing the information that has been rendered to the one of the plurality of regions of the second display, a percentage of the information that has been rendered to the one of the plurality of regions of the second display that the user has read or otherwise accessed, and a depth within the information that has been rendered to the one of the plurality of regions of the second display that the user has read or otherwise accessed.

In some implementations, the first display may be disposed on a first side of the apparatus and the second display may be disposed on a second side of the apparatus. The first side may be on an opposite side of the apparatus relative to the second side. In some other implementations, the display device may include the first display and the second display in another configuration.

In some implementations, the second display may consume less power than the first display. The second display may be an emissive display, a transmissive display, a reflective display, a partially transmissive and partially reflective display, an electrowetting display, or other suitable display. More particularly, in some implementations, the second display may be a bi-stable reflective display, such as a bi-stable interferometric modulator (“IMOD”) display. In some other implementations, the second display may be another type of IMOD display, such as an analog IMOD (AIMOD) display, also known as a multi-state IMOD display, or a single-mirror IMOD (SM-IMOD) display. In addition, the second display may include a touch-sensitive display.

In some implementations, the first display also may be an emissive display, a transmissive display, a reflective display, a partially transmissive and partially reflective display, an electrowetting display, or other suitable display. The first display also may be a touch-sensitive display.

In various implementations, the feedback may be received when a user interacts with the display device. More particularly, the feedback may include input that is received via the display device. The display device may support one or more mechanisms for receiving feedback via the display device. In some implementations, the feedback may be received via the second display. For example, the feedback may be received via the plurality of regions of the second display. Alternatively, the feedback may be received via another mechanism such as an input mechanism or sensor(s). Examples of input mechanisms and sensors that may be implemented will be described in further detail below.

In some implementations, the control system may be configured to process image data. The control system may include a driver circuit configured to send at least one signal to the first display or the second display or both, and a controller configured to send at least a portion of the image data to the driver circuit. The control system may include an image source module configured to send the image data to the processor. The image source module may include one or more of: a receiver, a transceiver, and a transmitter. The apparatus may include an input device configured to receive input data and to communicate the input data to the control system.

The control system may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. In some implementations, the control system may include a “system on a chip” that includes the general purpose single- or multi-chip processor and one or more of the DSP, ASIC, FPGA or other programmable logic device, discrete gate or transistor logic, or discrete hardware components. The control system also may include a memory storing thereon computer-readable instructions that, when executed by a processor, renders information to one or more of a plurality of regions of the second display according to various implementations.

Another innovative aspect of the subject matter described in this disclosure can be implemented in a non-transitory medium storing thereon instructions for performing the following process: identifying one or more sets of content generated or provided by one or more applications, prioritizing content within the sets of content or among the sets of content or both, and rendering information pertaining to at least a portion of at least one of the sets of content generated or provided by at least one of the applications to one or more of a plurality of regions of the second display according to a result of the prioritizing such that each of the at least one of the applications or content types associated therewith is mapped to a different one of the plurality of regions of the second display. The prioritizing may be performed based, at least in part, upon historical information pertaining to input that has been received with respect to information that has previously been rendered to at least one of the plurality of regions of the second display.

Details of one or more implementations of the subject matter described in this disclosure are set forth in the accompanying drawings and the description below. Although the examples provided in this disclosure are primarily described in terms of EMS and MEMS-based displays, the concepts provided herein may apply to other types of displays such as liquid crystal displays (LCDs), organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are examples of display devices having a first display and a second display.

FIG. 7A is a block diagram that shows components of a display device.

FIG. 7B is a block diagram that shows components of a display device.

FIG. 8 is a flow diagram illustrating an example method of rendering information to a second display of a display device having two or more displays.

FIG. 9 is a flow diagram illustrating another example method of rendering information to a second display of a display device having two or more displays.

FIG. 10 is a diagram illustrating an example screen shot of a second display of a display device.

FIGS. 11A and 11B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, a display device such as a handheld device may have a primary or first display and at least one other display, which will be referred to herein as a secondary or second display. In addition, the display device may include a control system. The control system may be configured to perform at least a portion of the disclosed processes. In addition, at least a portion of the disclosed processes may be performed by another network device such as a remotely located server.

A process of rendering information to the second display of the display device may include identifying or obtaining one or more sets of content generated or provided by one or more applications, determining whether to provide information pertaining to at least a portion of at least one of the sets of content to the second display, and rendering information pertaining to at least a portion of at least one of the sets of content to one or more of a plurality of regions of the second display according to a result of the determination.

In some implementations, the determination of whether to provide information to the second display may be made based upon a set of criteria that can include, for example, user feedback previously received with respect to information previously rendered to the second display. For example, performing such a determination may include prioritizing content within the sets of content or among the sets of content or both, as will be described in further detail below.

In such implementations, a process of rendering information to the second display of the display device may include identifying or obtaining one or more sets of content generated or provided by one or more applications and prioritizing content. The prioritization of content may include prioritizing content within the sets of content or prioritizing content among the sets of content or both. Information pertaining to at least a portion of at least one of the sets of content generated or provided by at least one of the applications may be rendered to one or more of a plurality of regions of the second display according to a result of the prioritizing such that each of the at least one of the applications or content types associated therewith is mapped to a different one of the plurality of regions of the second display. In some implementations, the prioritizing may be performed based, at least in part, upon historical information pertaining to feedback that has been received with respect to information that has previously been rendered to at least one of the plurality of regions of the second display.

In some implementations, the mapping between the applications or content types associated therewith and region(s) of the second display may be established via default settings or user preferences. In some other implementations, the mapping may be established via dynamic processes. For example, the mapping may be generated based, at least in part, upon a result of the prioritizing.

In some implementations, the first display may be disposed on a first side of the display device and the second display may be disposed on a second side of the display device. The first side of the display device may be a front side of the display device and the second side of the display device may be a rear side of the display device, or vice versa. In some other implementations, the display device may include the first display and the second display in another configuration. For example, in some implementations, both the first display and the second display may reside on the same side of the device. In alternative implementations, the first display may be on an internal surface of the device and the second display may be on an external surface of the device. In some other implementations, the first display and the second display may be connected via a hinge or other mechanism supporting rotation, such as in a “clamshell” configuration

The second display may be any type of display. In some implementations, the second display may, for example, be a reflective display that consumes less power than the first display. For example, the second display may be a bi-stable reflective display, such as a bi-stable interferometric modulator (IMOD) display. In some other implementations, the second display may be another type of IMOD display, such as an analog IMOD (AIMOD) display, also known as a multi-state IMOD display, or a single-mirror IMOD (SM-IMOD) display. In some implementations, the second display also may be a touch-sensitive display.

In various implementations, the display device may support one or more mechanisms for receiving feedback via the display device. The control system may be configured to receive feedback via the second display. The control system also may be configured to receive feedback via another mechanism such as an input mechanism or sensor(s) of the display device or both. Characteristics of the feedback that is periodically received via one or more such mechanisms may be stored as historical information.

In some implementations, the historical information may update a machine learning algorithm. Therefore, the prioritization may be accomplished via a machine learning algorithm. The prioritization may be performed via the control system of the display device or a network device such as a remotely located server. Particular implementations of the subject matter described in this disclosure can be implemented to realize one or more of the following potential advantages. By implementing the second display as a reflective display such as a bi-stable reflective display or analog reflective display, it is possible to partially update the second display such that one or more of a plurality of regions of the second display are updated without updating the entire second display. The ability to update selected region(s) of the second display may result in reduced power consumption and increased lifetime of components of the second display. In addition, the ability to update selected region(s) of the secondary display may result in an increased frame rate, resulting in less perceived flicker and reduced eye strain. In addition, the manner in which the second display is updated may be customized according to feedback that is received via the display device. For example, the region(s) that are updated may be selected based, at least in part, upon user specified feedback received via the display device. As another example, the amount of information rendered to a particular region or the specific information that is rendered to a particular region or both may be selected based, at least in part, upon feedback received via the display device. As a result, information may be presented in a manner that is customized for the particular display device and the user(s) of the display device.

An example of a suitable EMS or MEMS device or apparatus, to which the described implementations may apply, is a reflective display device. Reflective display devices, such as devices that include a two or more displays as described herein, can incorporate IMOD display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

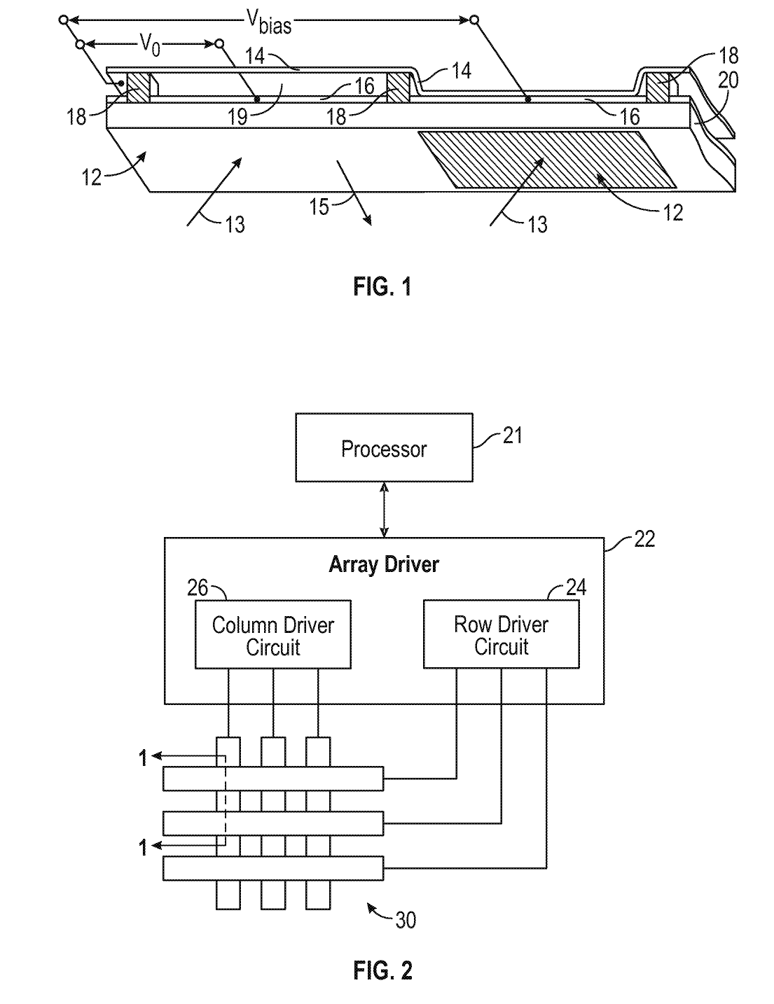

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated, depending on a targeted gap height. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.1, 0.2, 0.3, 0.5 or 0.7 millimeters, although in some implementations the glass substrate can be thicker (such as tens of millimeters) or thinner (such as less than 0.3 millimeters). In some implementations, the glass substrate may be bendable. In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

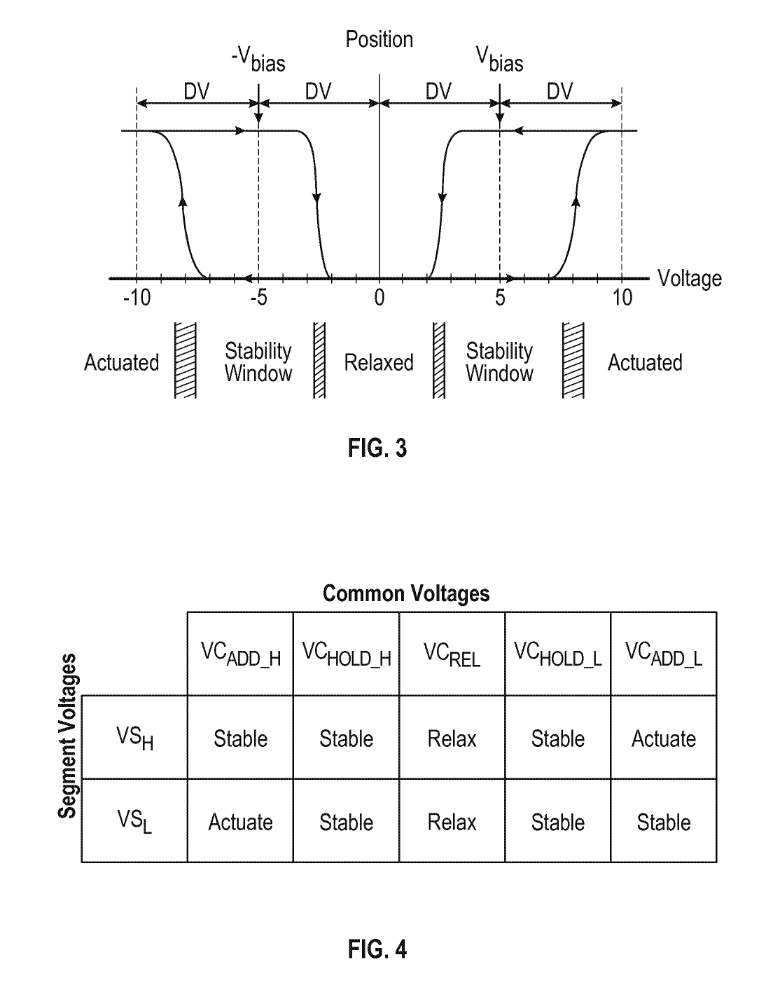

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

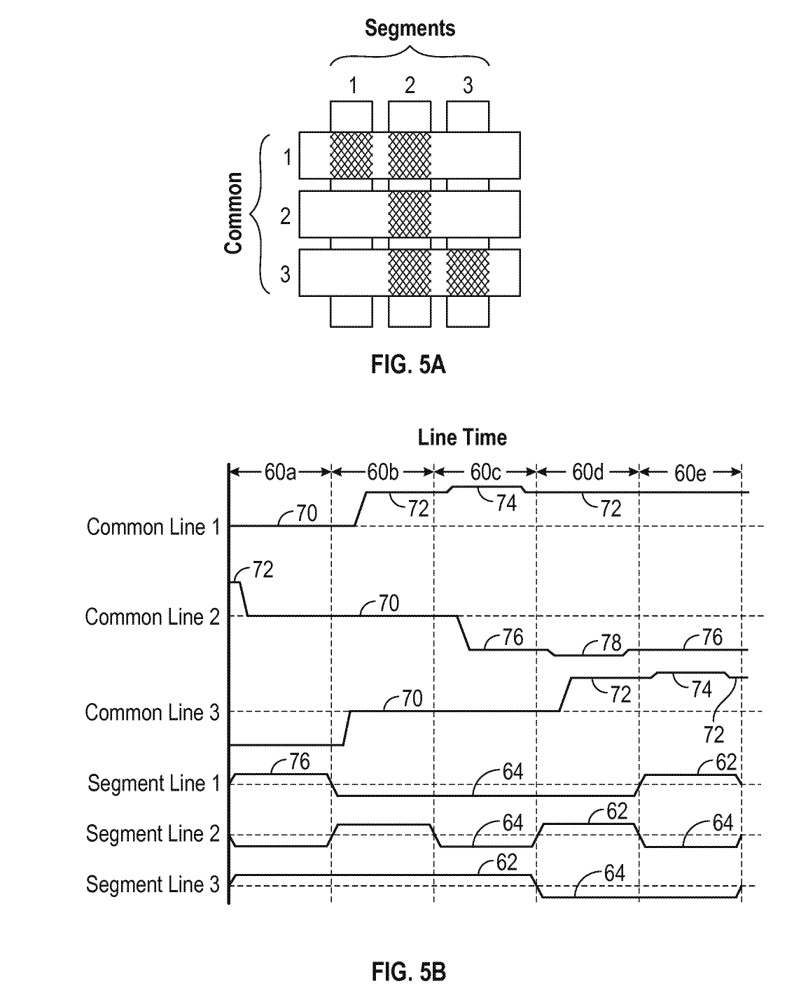

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

In some implementations, a display device may include an active-matrix IMOD display. More particularly, an active-matrix IMOD display may include an array of pixels, where each pixel includes at least one IMOD display element and at least one pixel actuation switch that actuates the IMOD display element. Active-matrix displays constructed from IMOD elements as compared to passive-matrix IMOD displays can exhibit the following qualities, for example, low power consumption, high frame (video) rate, and improved color saturation.

In active-matrix IMOD display applications, the actuation of IMOD display elements is often achieved using thin-film transistors (TFTs) as pixel actuation switches. For example, the TFTs may include low off state leakage transistors such as amorphous silicon, indium gallium zinc oxide (IGZO) TFTs or low temperature polysilicon (LTPS) TFTs.

In some implementations, the IMOD display elements may include bi-stable IMODs. Bi-stable IMODs can be configured in only two positions, open or closed. More particularly, a pair of plates (or layers), i.e., a reflector and absorber, may be positioned with respect to one another in only two different configurations. As a result, bi-stable IMODs may switch between only two color states, black and white. A single image pixel may include multiple bi-stable IMODs, each of which corresponds to a subpixel.

In some other implementations, the IMOD display elements may include AIMODs, which may considered a category of SM-IMODs. Each AIMOD (or SM-IMOD) may correspond to a single pixel. In a display device that includes AIMODs (or SM-IMODs), a pixel's reflective color may be determined by the gap spacing or “gap height” between the pair of plates (or layers), i.e., a reflector and absorber, of a single IMOD. As a result, the pixel's reflective color may be varied by changing the gap height between the two layers. In a SM-IMOD implementation, the reflector also may be referred to as a mirror, which may include at least one metallic reflective layer, which also may be referred to as a mirrored surface. SM-IMODs can produce vivid, saturated colors under bright ambient light conditions.

In some implementations, a display device, such as a smartphone, e-reader, tablet, notebook, smartbook, netbook, laptop, or other such display devices, may include more than one display. In implementations having two or more displays, the display device may include a first or primary display and a second or secondary display. In some implementations, the display device may include displays on more than one side of the display device. In some implementations, the first display may be on one side of the device and the second display may be on another side of the device. In some other implementations, both the first display and the second display may reside on the same side of the device. In alternative implementations, the first display may be on an internal surface of the device and the second display may be on an external surface of the device. In some other implementations, the first display and the second display may be connected via a hinge or other mechanism supporting rotation, such as in a “clamshell” configuration. In such implementations, the first display and the second display may both be visible to the user when information is rendered to the second display.

In some implementations, the second display may be a reflective display. More particularly, the reflective display may be a bi-stable reflective display such as a bi-stable IMOD display, which may consume less power than the first display. In some other implementations, the second display may be another type of IMOD display, such as an AIMOD display or SM-IMOD display.

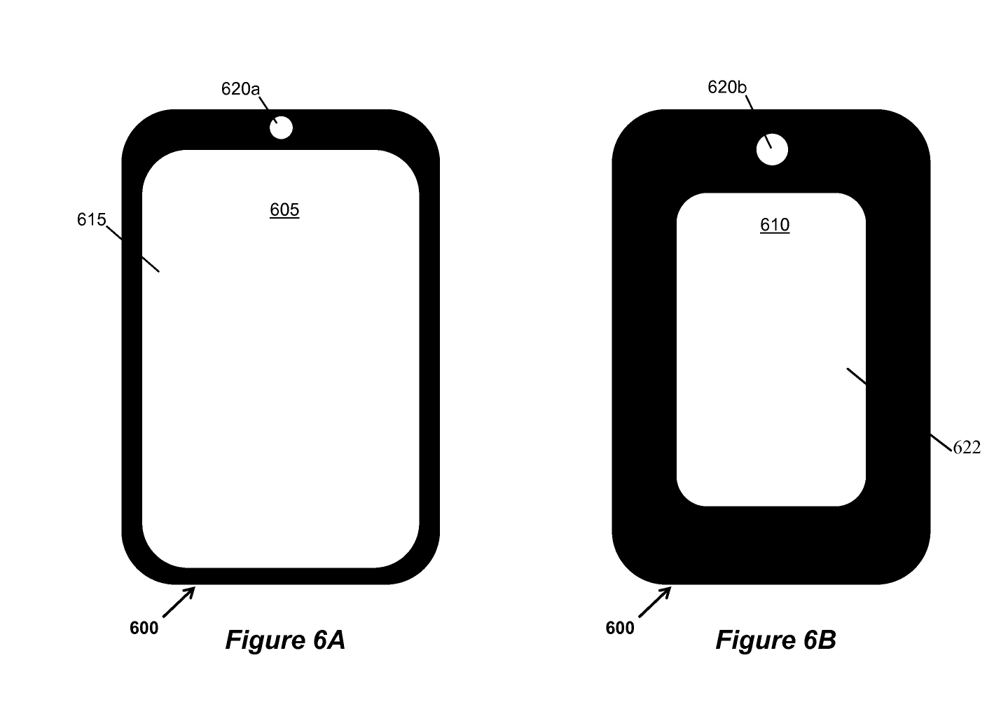

FIGS. 6A and 6B are examples of display devices having a first display and a second display. More particularly, FIG. 6A is a diagram illustrating a first side of the display device, while FIG. 6B is a diagram illustrating a second side of the display device. The first side of the display device may be referred to as the “front” of the display device, while the second side of the display device may be referred to as the “rear” or the back of the display device. However, a person having ordinary skill in the art will readily recognize that these directional terms are arbitrary, and in fact the first display may be located on the rear side of the device, and the second display may be located on the front side of the device. As shown in FIG. 6A, the first side of the display device 600 may include a first display 605. The first display 605 may include a touch-sensitive display 615. The first display 605 may be an emissive display, a transmissive display, a reflective display, a partially transmissive and partially reflective display, an electrowetting display, or other suitable display.

As shown in FIG. 6B, the handheld device 600 may include at least a second display 610, which also may be referred to as a secondary display. As shown in this example, the second display 610 may be disposed on the second side of the display device 600. The second display 610 may include a touch-sensitive display 622. The second display 610 may include an emissive display, a transmissive display, a reflective display, a partially transmissive and partially reflective display, an electrowetting display, or other suitable display. In some implementations, the second display 610 may be disposed on another part or side of the display device 600. For example, the display device 600 may include two or more portions connected by a hinge, such as in a clamshell configuration. Therefore, the first display 605 may be disposed on a first portion of the display device 600, while the second display 610 may be disposed on another portion of the display device 600.

In various implementations, the second display 610 may consume less power than the first display 605. For example, the first display 605 may be an emissive or a transmissive display, such as an OLED-based display or an LCD-based display, whereas the second display may be a lower power display. In some implementations, the second display 610 may be a reflective display, or a bi-stable reflective display, such as a bi-stable IMOD display. In some other implementations, the second display 610 may be another type of IMOD display, such as an AIMOD display or SM-IMOD display.

As shown in this example, the display device 600 also may include a camera system 620. In this example, the camera system 620 may include a camera 620a disposed on the first side of the handheld device 600, or a camera 620b disposed on the second side of the handheld device 600, or a camera on both sides of the display device 600.

The appropriate display may be controlled according to input (or feedback) received via the touch-sensitive display 615 or 622 or input (or feedback) received via another input mechanism. More particularly, the display device 600 may include various input mechanisms such as a microphone for accepting voice input. In some implementations, feedback with respect to information rendered to region(s) of the second display may be received as voice input or commands via the microphone.

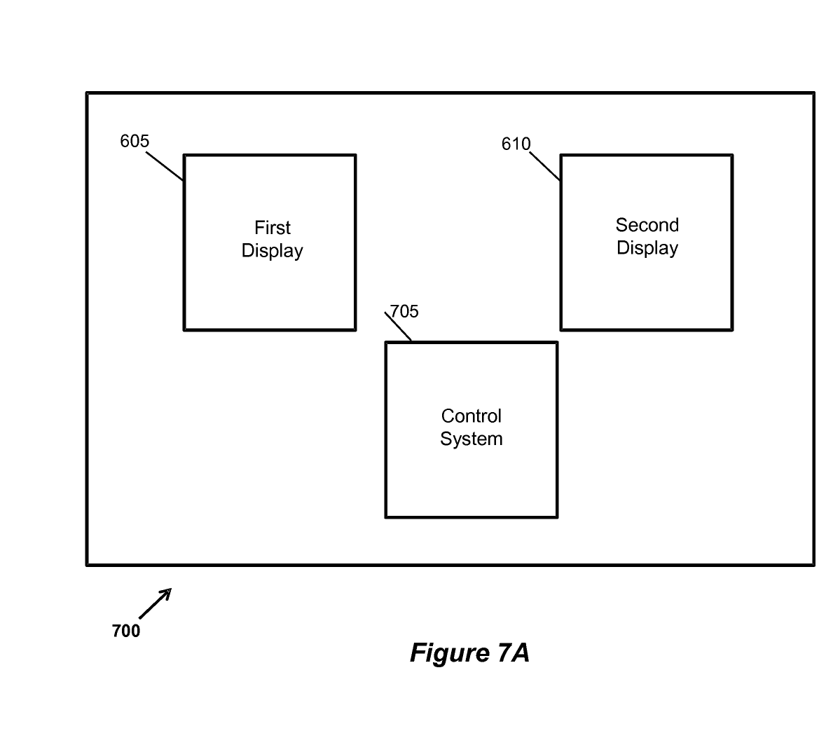

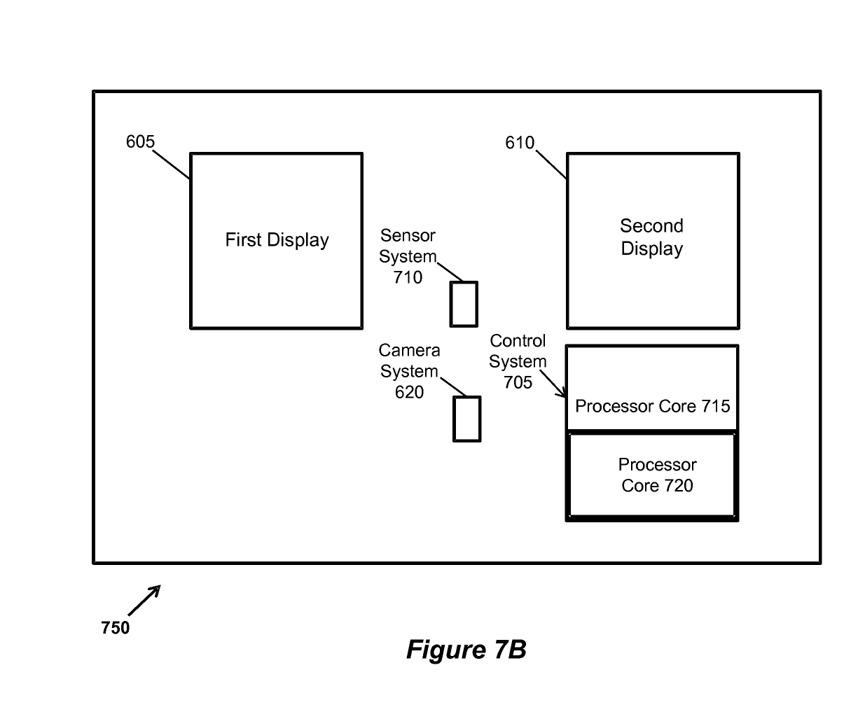

FIG. 7A is a block diagram that shows components of a display device. In the example shown in FIG. 7A, the display device 700 includes the first display 605, the second display 610, and a control system 705. The first display 605 may include a touch-sensitive display 615 for receiving input. Similarly, the second display 610 may include a touch-sensitive display 622 for receiving input. In addition, the display device 700 may include one or more other input mechanisms.

The control system 705 may be configured to control the first display 605 and the second display 610. More particularly, in some implementations, the control system 705 may include a single controller that controls both the first display and the second display, while in some other implementations the control system 705 may include a first controller that controls the first display 605 and a second controller that controls the second display 610.

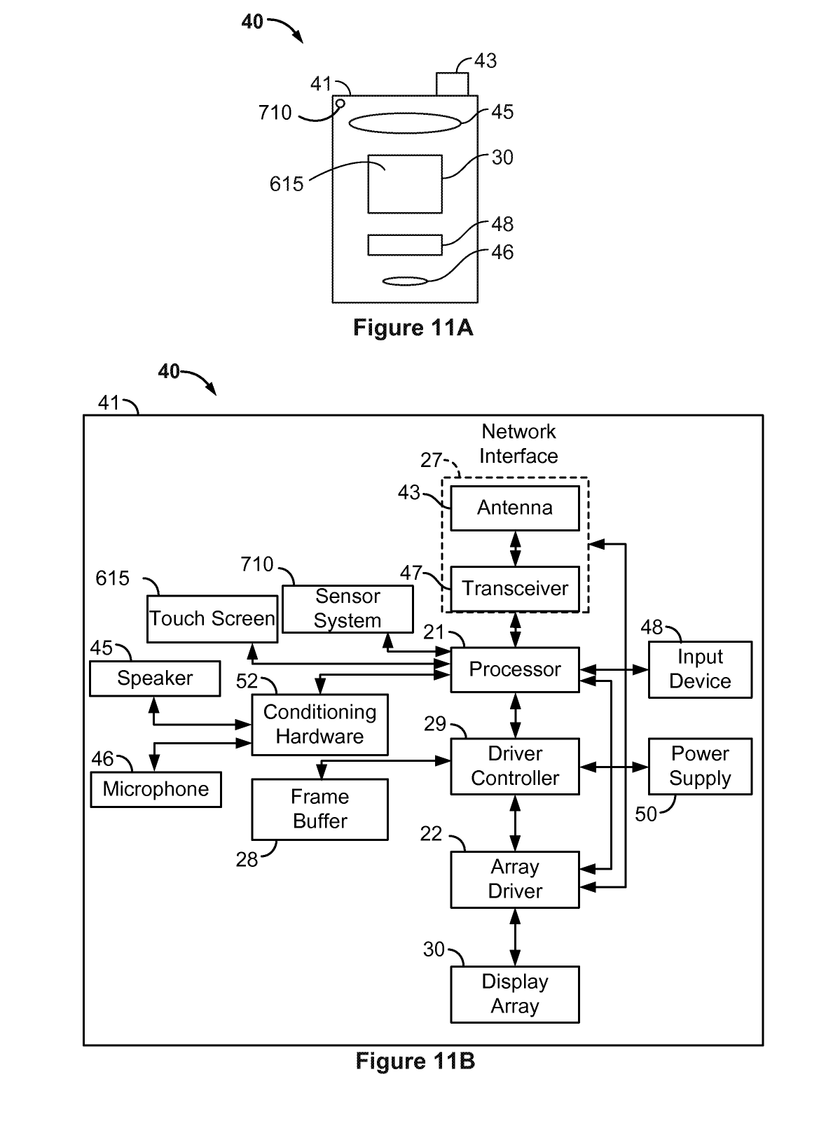

The control system 705 may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. In some implementations, the control system may comprise a “system on a chip” that includes a general-purpose processor and one or more other logic devices such as DSPs, ASICs, or FPGAs. Accordingly, the control system 705 may be implemented by a processor or another component of the display device, as will be described in further detail below with reference to FIGS. 11A and 11B.

As noted above, the first display 605 and the second display 610 may be on opposite sides of the display device 700. Therefore, when a user is viewing the second display 610, the first display 605 may be powered off with no detriment to the user's experience. The control system 705 may be configured to control the second display 610, even when the first display 605 is powered off.

A user may provide feedback with respect to information rendered to the second display 610. More particularly, the user may provide feedback by interacting with the display device 700. An interaction of the user with the display device 700 may be detected via a variety of mechanisms. A user may interact with information rendered to the second display 610 by submitting input to the display device 700. In some implementations, the user may provide input to the display device 700 by interacting with the touch-sensitive display 622 of the second display 610 or the touch-sensitive display 615 of the first display 605. In some other implementations, the display device 700 may be configured such that a user's feedback is detected via other mechanism(s), such as via a microphone or sensor system. An example sensor system will be described in further detail below with reference to FIG. 7B. As will be described in further detail below, the feedback received via the display device 700 may be used to prioritize content or corresponding information, enabling the information to be rendered to corresponding portion(s) of the second display 610 according to a result of the prioritization.

A user may interact with the second display 610 by providing taps, swipes or other gestures, etc., to the second display 610. For example, the user may interact with the second display 610 by using a finger or stylus to tap or swipe the second display 610. In some implementations, the touch-sensitive display 622 of the second display 610 may be configured to receive user input via a number of single-touch or multi-touch gestures or both, such as tap, double tap, long press, scroll, pan, flick, two-finger tap, two-finger scroll, pinch, spread and rotate. In some other implementations, the second display 610 or sensor(s) implemented by the display device 700 may detect gestures of a user, even where the user does not touch the second display 610. For example, the sensor(s) may detect a proximity of an appendage of the user or other implement that is present within a particular distance from, or hovers over, at least a portion of the second display 610. As another example, the sensor(s) may detect motion of an appendage of the user or other implement that moves over at least a portion of the second display 610. In some other implementations, a user also may “interact” with the second display via other mechanisms, such as via voice commands transmitted via a microphone. In some other implementations, where a user cannot use his hands due to a physical or cognitive impairment or disability, the user may use an assistive technology product, which may be activated, for example, by ultrasound, infrared beams, eye movements, brain waves, inhaling, or exhaling.

FIG. 7B is a block diagram that shows components of a display device. In this example, the display device 750 includes a camera system 620 and a sensor system 710. In some implementations, the control system 705 may be configured to control the second display 610 or the first display 605 or both based on the occurrence (or non-occurrence) of certain events or feedback, at least some of which may be determined according to sensor data from the sensor system 710. In some such implementations, the control system 705 may be configured to activate or de-activate the first display 605 or the second display 610 or both based on sensor data from the sensor system 710. Moreover, in some implementations, the control system 705 may be configured to interpret the sensor data (or a portion thereof) from the sensor system 710 as feedback with respect to information rendered via the second display 610.

In some implementations, the sensor system 710 may include a motion sensor such as one or more accelerometer(s). The sensor system 710 also may include one or more orientation sensors such as one or more of: a gyroscope, a magnetometer and a proximity sensor. The control system 705 may use a combination of input from one or more motion sensors or one or more orientation sensors or both to receive or detect feedback. For example, where the user interacts with the display device 750 by lifting or rotating the display device 750 in response to the rendering of information such as an incoming text or email message, a news headline, or information received via a social media application to one or more regions of the second display 610, this interaction with the display device 750 may indicate interest of the user in the information being rendered to the second display 610. Accordingly, the control system 705 may use a combination of input received from one or more of the sensor system 710, the second display 610, or other input mechanism(s), or their inputs individually, to obtain feedback.

In the example shown in FIG. 7B, the control system 705 may include one or more processor cores 715 and 720. As noted above, the control system 705 also may include other elements that are not shown in FIG. 7B. In some implementations, at least one of the processor cores of the control system 705 may execute at a higher processor speed, and therefore may consume relatively more power than other processor cores of the control system 705. In this example, one or more processor cores 715 may be higher-power processor cores and one or more additional processor cores 720 may be lower-power processor cores. For example, at least one of the processor cores 715 may be an applications processor core. The higher-power processor core(s) may be configured to power a display that consumes more power or may be configured to execute applications that may benefit from a faster processor speed. Similarly, the lower-power processor core(s) may be configured to power a display that consumes less power or may be configured to execute applications that are capable of executing on processors having lower processor speeds. Accordingly, one or more lower-power processor cores may be used to enable power to be conserved.

In some implementations, due to the relatively low power consumption of a display such as an analog, single-mirror, or bi-stable reflective display, at least one of the lower-power processor cores 720 may be configured to power the second display 610. In addition, at least one of the higher-power processor cores 715 may be configured to power the first display 605. Alternatively, the first display 605 or the second display 610 or both may be powered according to a type of application that is controlling the corresponding display or portion thereof. More particularly, the control system 705 may be configured to turn one of the higher-power processor cores 715 on or off according to a type of application that is being used to control the second display 610 or portion thereof. For example, if a gaming application is being run and corresponding graphics are being shown on at least a portion of the second display 610, the control system may be configured to turn an applications processor core on and to execute the gaming application on the applications processor core. As another example, when information such as incoming text messages, electronic mail notifications, the time of day, the weather, etc., is being rendered to one or more regions of the second display 610, the control system 705 may be configured to run the pertinent applications on one or more of the lower-power processor cores 720. Thus, when the second display 610 is not powered by at least one of the higher-power processor cores 715, the second display 610 may be powered by one of the lower-power processor cores 720. In other words, in a default state of some implementations, the second display 610 may be powered by one of the lower-power processor cores 720. Accordingly, the second display 610 may be operated in an “on” state for an extended period of time while consuming relatively little power.

At any given point in time, the display device may be in one of the following four states: both the first display and the second display are on, both the first display and the second display are off, the first display is on and the second display is off, or the first display is off and the second display is on. In some implementations, the first display and the second display may be turned on or off independently, either manually in response to user input or initiated by the control system 705. Accordingly, the first display and the second display may be separately controlled.

In some implementations, the first display and the second display may be controlled by a single, common controller, which can include a processor such as a microcontroller, central processing unit (CPU), or logic unit to control operation of the display device. More particularly, the controller may be implemented in hardware or software or both. A processor may be configured to communicate with the first display or the second display or both, and may be configured to process image data. An input device of the display device or an input device communicating with the display device may be configured to receive input data and to communicate the input data to the processor. The display device may include a driver controller, such as a driver circuit, configured to send at least one signal to the first display or the second display or both. The controller may be configured to send at least a portion of the image data to the driver controller. In addition, an image source module may be configured to send the image data to the processor, wherein the image source module includes at least one of a receiver, transceiver, or transmitter. A memory device may be configured to communicate with the processor, and may store computer-readable instructions for controlling the first display and the second display as disclosed herein. An example display device, controller, and driver controller are described in further detail below with reference to FIGS. 11A and 11B.

In some other implementations, the first display may be controlled by a first controller, while the second display may be controlled by a second controller. The first and second controller may each include a processor such as a microcontroller, CPU, or logic unit. Each controller may be implemented in hardware, software, or both hardware and software. A first processor may be configured to communicate with the first display, and may be configured to process image data. Similarly, a second processor may be configured to communicate with the second display, and may be configured to process image data. An input device of the display device or an external input device communicatively coupled to the display device may be configured to receive input data and to communicate the input data to the first processor or the second processor or both. Such an external input device may include a variety of commonly used input devices such as keyboards, trackballs, joysticks, or microphones. An external input device also may include one or more assistive technology products such as electronic pointing devices, sip-and-puff systems, or wands that may be used by individuals who have physical or cognitive difficulties, impairments, or disabilities. For example, various assistive technology products may be activated by ultrasound, infrared beams, eye movements, brain waves, inhaling, or exhaling. The display device may include at least one driver controller such as a driver circuit configured to send at least one signal to the first display or the second display or both. The primary controller or secondary controller or both may be configured to send at least a portion of the image data to the driver controller. In addition, an image source module may be configured to send the image data to the first processor or the second processor or both, wherein the image source module includes at least one of a receiver, transceiver, or transmitter. A memory device may be configured to communicate with the first processor or the second processor or both, and may store computer-readable instructions for controlling the corresponding processor(s).

In some implementations, the second display may be operated for an extended period of time at a low refresh rate. As will be described in further detail below, the second display may be updated based, at least in part, upon feedback that has been received via the display device. In addition, in some implementations, the second display may be partially updated without updating the entire display, enabling power to be conserved.

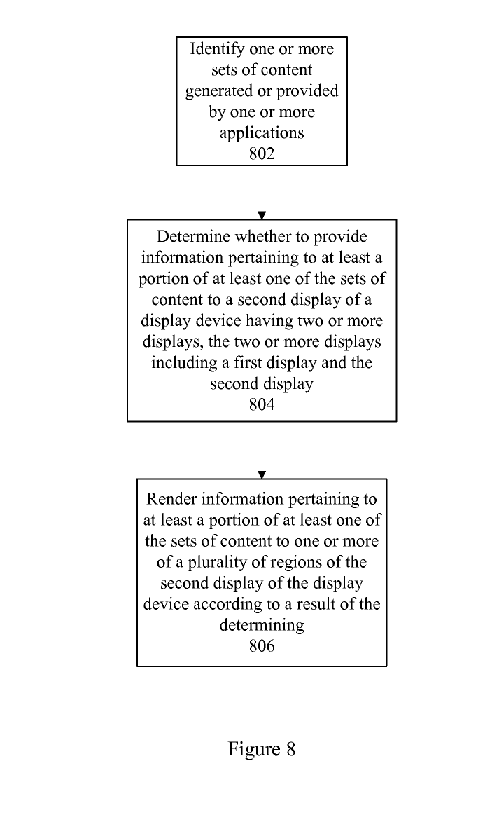

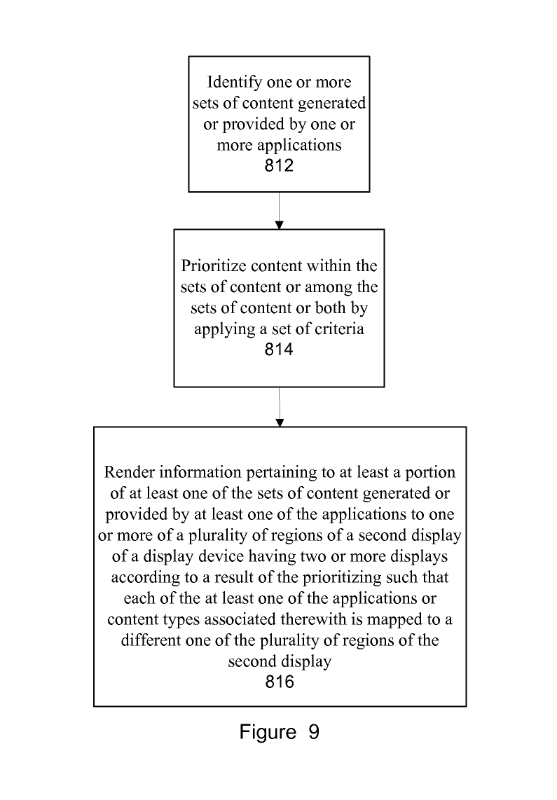

Example methods of implementing a display device having two or more displays will be described below with reference to FIGS. 8 and 9. Operations of each of the methods may be performed at a network device such as a remotely located server, at the display device, or both the network device and the display device. Thus, one or more of the methods may be performed entirely at the remotely located server, entirely at the display device, or may be performed partially at the network device and partially at the display device. More particularly, the network device may be communicatively coupled to the display device via an interface, which may include a wireless interface, over a network such as a wide area network (WAN). Each of the methods may be implemented via hardware, software, or both hardware and software, where the hardware or software or both are implemented at the network device, the display device, or both the network device and the display device. The software may be stored as one or more sets of computer-readable instructions that can be executed via a processor of the network device, a processor of the display device, or both a processor of the network device and a processor of the display device. Thus, at least one of the sets of computer-readable instructions may be stored in a memory of the network device or an external memory communicatively coupled to the network device. Similarly, at least one of the sets of computer-readable instructions may be stored in a memory of the display device, an external memory communicatively coupled to the display device, or both a memory of the display device and an external memory communicatively coupled to the display device. At least one of the sets of computer-readable instructions also may be stored on a non-transitory computer-readable medium.

FIG. 8 is a flow diagram illustrating an example method of rendering information to a second display of a display device having two or more displays. The process may be performed even when the first display is powered off. In some implementations, the display device may be substantially similar to the display device 600 shown in FIGS. 6A-6B. As shown in FIG. 8, one or more sets of content generated or provided by one or more applications may be identified or obtained at block 802. Example applications include, but are not limited to, an electronic mail application, a text messaging application, a phone application, and a clock application. Each of these applications may generate or provide a different content type. For example, a plurality of content types may include electronic mail messages, text messages, phone calls, or clock output, which may indicate a time or date, or both a time and date. A person having ordinary skill in the art will readily understand that other sets of content and applications can be used interchangeably in this flow diagram. The applications may be installed on the display device, on at least one network device such as a remotely located server, or on both the display device and at least one network device. Thus, the display device may be connected through one or more interface mechanisms, which may include a wired or wireless connection, to one or more network devices including the at least one network device via a network such as a WAN.

At block 804, it may be determined whether to provide information pertaining to at least a portion of at least one of the sets of content to a second display of a display device having two or more displays, where the two or more displays include a first display and the second display. For example, the information may include notifications or status information such as an indication of receipt of an electronic mail message, text message, or phone call. As another example, the information also may include actual content such as an electronic mail message, text message, or phone message. The determination may be performed, at least in part, via a controller of the display device. Moreover, the determination may be performed, at least in part, via another network device that is separate from the display device, such as a remotely located server.

The determination may be made based, at least in part, upon a set of criteria. In some implementations, the set of criteria may include contextual information indicating a context in which the display device is operating. The contextual information may pertain to one or more of a physical location of the display device or user, an orientation of the display device, or a physical environment in which the display device is operating. For example, the contextual information may indicate lighting conditions or that the display device has been placed down (or picked up).

The set of criteria also may include the content type(s) or the application(s) to which the at least a portion of at least one of the sets of content pertains or both the content type(s) and the application(s). More particularly, a content type or an application to which the at least a portion of at least one of the sets of content pertains may be identified. It may then be ascertained whether to provide information pertaining to the identified content type or application to the second display.

The determination as to whether to provide information pertaining to particular content type(s) or particular application(s) or both to the second display also may be made based, at least in part, upon historical information pertaining to user feedback with respect to information previously rendered to the second display, historical information pertaining to user activity with respect to the particular applications or particular content type(s) associated therewith or both, or historical information pertaining to both the user feedback and the user activity. In some implementations, the user feedback can include a user's input with respect to the information that has been rendered to the second display. More particularly, the user's input may include a user's response(s) to the information that has been rendered to the second display or other activity of the user with respect to the information that has been rendered to the second display. For example, the user feedback may be detected when the user performs a gesture such as swiping, clicking or double-clicking on a portion of the second display in which the information is rendered. As another example, the user feedback may be detected when the user picks up the display device or rotates the display device. Similarly, if the user ignores information provided by the second display for at least a minimum period of time or ignores a portion of the second display for at least a minimum period of time, the lack of feedback also may be detected. The user activity with respect to a particular application or corresponding content type can include accessing or opening the application. For example, the user activity can include initiating a phone call via a phone application. The user activity also can include browsing activity of the user via the display device or another device operated by the user. Therefore, the user feedback or user activity or both may be detected, at least in part, via the display device.

As feedback is received or user activity is detected, the historical information may be updated. The historical information may be stored in a memory of the display device or in one or more data stores that are external to the display device or both. More particularly, the one or more data stores may be connected to the display device or may be remotely located. For example, such a data store may include a subscriber identification module (SIM) card or a remotely located server.

The set of criteria also may include a popularity of content items, subjects, or authors, which may be ascertained from user feedback or user activity of a plurality of users, or both user feedback and user activity of a plurality of users. For example, users may vote, submit comments, tag, or otherwise indicate those content items, subjects, or authors that are of particular interest to them. As another example, a time spent by users or a number of clicks by users with respect to particular content items may indicate a popularity of the content items. The popularity of content items, subjects, or authors may be ascertained via a network device such as a remotely located server.

In some implementations, the determination may be made via a machine learning algorithm that is periodically updated with the historical information. In some implementations, the machine learning algorithm may be implemented via a controller of the display device. In some other implementations, the machine learning algorithm may be implemented via another network device such as a remotely located server.

The second display may include a plurality of regions. More particularly, each of the plurality of regions of the second display may be mapped to a different one of a plurality of content types or a different one of a plurality of applications. Thus, the determination may include determining whether to provide information pertaining to at least a portion of at least one of the sets of content to one or more of the plurality of regions of the second display. Accordingly, the determination as to whether to provide the information pertaining to at least a portion of at least one of the sets of content may be made with respect to one or more content types or applications corresponding to one or more of the plurality of regions of the second display.

The determination whether to provide information pertaining to at least a portion of at least one of the sets of content to a second display of a display device having two or more displays may be accomplished by prioritizing the content within the sets of content or among the sets of content or both, as will be described in further detail below with reference to FIG. 9.

At block 806, the information pertaining to at least a portion of at least one of the sets of content may be rendered to one or more of a plurality of regions of the second display according to a result of the determining. More particularly, the information may be rendered to the entire second display. Alternatively, the second display may be partially updated without updating the entire display in accordance with various criteria such as those described herein.

FIG. 9 is a flow diagram illustrating an example method of rendering information to a second display of a display device having two or more displays. The process may be performed even when the first display is powered off. In some implementations, the display device may be substantially similar to the display device 600 shown in FIGS. 6A and 6B. As shown at block 812 in FIG. 9, one or more sets of content generated or provided by one or more applications may be identified or obtained. For example, the applications may include one or more of an electronic mail application, a text messaging application, a phone application, or a clock application. Each of these applications may generate or provide a different content type. For example, a plurality of content types may include electronic mail messages, text messages, phone calls, or clock output, where the clock output indicates a date or time or both. A person having ordinary skill in the art will readily understand that other sets of content and applications can be used in this flow diagram. The applications may be installed on the display device, on at least one network device such as a remotely located server, or both the display device and at least one network device. Thus, the display device may be connected through one or more interface mechanisms, which may include a wired or wireless connection, to one or more network devices including the at least one network device via a network such as a WAN.

At block 814, content may be prioritized within the sets of content or among the sets of content or both by applying a set of criteria. Thus, prioritization of content may indicate those sets of content or subsets thereof, or corresponding applications, that are likely to be of interest to a user of the display device or other users or both, who may each use a device such as the display device or a similar device. More particularly, the prioritization may be performed based, at least in part, upon feedback or activity of the user or other users. For example, the prioritization may be performed based, at least in part, upon feedback that has been received as a result of crowdsourcing. Similarly, the prioritization of the content may indicate those sets of content or subsets thereof that are not likely to be of interest to the user of the display device. For example, electronic mail messages within a set of electronic mail messages may be prioritized such that electronic mail messages from work colleagues are ranked at a higher priority than electronic mail messages received from social contacts. As another example, prioritization among the sets of content may result in ranking phone calls at a higher priority than electronic mail messages, but lower in priority than text messages. Therefore, the prioritization may rank the sets of content, content items within a set of content, or both the sets of content and content items within a set of content to indicate a level of importance to a user of the display device.

Prioritizing content among the sets of content may include selecting at least one of the applications for which to render information. For example, prioritizing may be performed, at least in part, via a controller of the display device. As another example, prioritizing may be performed, at least in part, via at least one other network device that is separate from the display device, such as a remotely located server. This may be accomplished by prioritizing the applications or content types associated therewith.

The prioritization may further include obtaining, selecting or generating a mapping such that each of the at least one of the applications or content types associated therewith is mapped to a different, corresponding one of the plurality of regions of the second display. For example, a mapping may be dynamically generated based, at least in part, upon a result of the prioritizing. As another example, a mapping that has previously been established via default or user settings may be obtained. Such a mapping may be generated, obtained, or selected via a controller of the display device. In this manner, it is possible to select or identify a physical configuration or order in which the sets of content are to be displayed among the plurality of regions of the second display.

In some implementations, the obtaining, selecting, or generating the mapping may include ascertaining or establishing an optimal size or shape or both of each of the regions of the second display that is mapped to one of the applications or content types associated therewith. In some implementations, the size of one of the regions may be modified to enlarge or reduce the size, which also may impact the size of other region(s) of the second display. For example, the region devoted to sports updates may be enlarged where it is determined that a user of the display device is particularly interested in sports. Similarly, the shape of one of the regions may be modified, which also may impact the shape of other region(s) of the second display. In some instances, the size of the region(s) mapped to a particular application or content type associated therewith may be of a significant size such that the application or associated content type is mapped to the entire second display.

The prioritization of content within one of the sets of content may include selecting at least a portion of the one of the sets of content for which to render information, selecting a physical configuration or order in which the at least a portion of the one of the sets of content or information associated therewith is to be displayed within the corresponding one of the plurality of regions of the second display, or selecting a sequence in time in which the at least a portion of the one of the sets of content or information associated therewith is to be rendered.

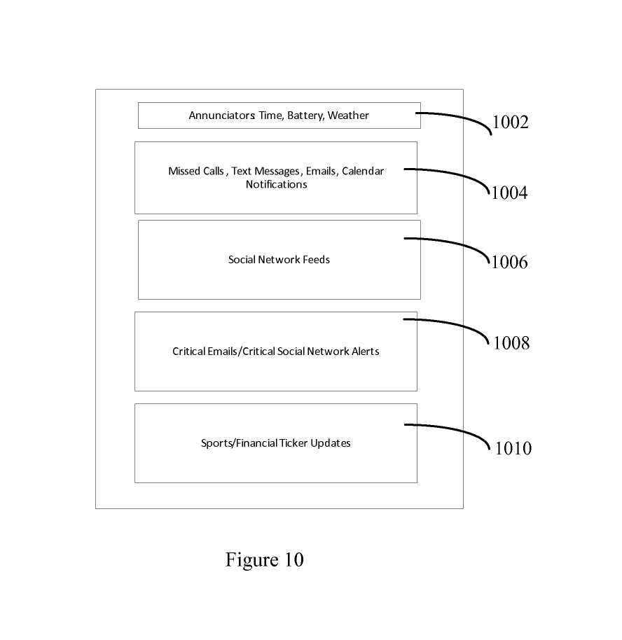

The criteria used to prioritize the content within the sets of content or among the sets of content may include contextual information such as user physical location or orientation of the display device or user feedback that has been received with respect to information that has previously been rendered to region(s) of the second display. The user feedback may be received via one or more mechanisms. For example, mechanisms may include sensors, in addition to other input mechanisms described herein. In some implementations, the user feedback may include user input received via the display device with respect to particular applications, content types, sets of content, or portions thereof. For example, a user may double tap a particular content item to view, retrieve or otherwise access a content item, or to indicate that they “like” or “prefer” a content item. In another example, a user may, swipe or double-tap “dislike” to skip a content item. In this manner, the user may vote, submit comments, tag, or otherwise indicate those content items, subjects or authors that are of particular interest to them. The receipt and processing of user feedback received via the display device will be described in further detail below with reference to FIG. 10.

The criteria used to prioritize content within the sets of content or among the sets of content also may include user activity such as activity with respect to application(s) generating or providing the sets of content. User activity may include activity with respect to a particular application such as accessing or opening the application. For example, the user activity can include initiating a phone call via a phone application. The user's prior activity with respect to the applications may indicate the frequency with which the user accesses specific applications. For example, the user's prior activity may indicate that the user has used the phone application 100 times within the last week, but has only used the text messaging application 10 times within the last week. From the user activity, it is possible to ascertain a level of interest of the user in the application(s) or content type(s) generated or provided by the application(s).

The user activity also may include browsing activity, which may indicate the number of times a particular content item has been read or otherwise accessed. The browsing activity of the user may be performed via the display device or another device operated by the user. In some implementations, the subjects or authors or both of particular content items may be ascertained via content tags. For example, natural language processing may be implemented to obtain content tags for content items such as news items. In this manner, it is possible to ascertain a level of interest of the user in specific content items, subjects, or authors.

In some implementations, the frequency of occurrence of terms within documents such as emails or web pages may indicate a level of user interest in topics represented by those terms. For example, those terms that occur most frequently may indicate a high level of interest of the user in the topics represented by those terms. In some implementations, one or more algorithms may be applied to correlate a frequency of occurrence of terms with priorities with respect to those terms. In some implementations, various algorithms may be applied to generate priorities of terms based, at least in part, upon the frequency of occurrence of various terms. An example algorithm that may be applied is Zipf's law, while its derivatives also may be applied. For example, according to Zipf's law, the elements of a finite dataset may be prioritized according to the frequency of occurrence of each of the elements.

In some implementations, the elements of a dataset such as terms within documents also may be prioritized based, at least in part, upon corresponding weights. More particularly, each element of a dataset may have a corresponding weight that indicates a relevance of the element. For example, the weight may indicate the relevance of the element to a particular context or user or both. Such weights may be generated via a machine learning algorithm. The weights may be generated based, at least in part, upon information received from one or more sources or services. More particularly, the sources may include the sensor system. For example, the information received from the sources or services may indicate a location of the user. In addition, the weights may be generated based, at least in part, upon historical information that has been gathered over time. For example, where a user has not responded to a particular element of a dataset in the past, the weight may be reduced. A lower weight may reduce the priority of an element of a dataset, even where the element has a high frequency of occurrence.

The criteria used for prioritization also may include a popularity of content items, subjects, or authors. The popularity of content items, subjects, or authors may be ascertained from user feedback of a plurality of users or user activity of a plurality of users or both. Such user feedback of a plurality of users or user activity of a plurality of users or both may be detected via various network devices, which may include display devices such as that described herein. For example, users may vote, submit comments, tag, or otherwise indicate those content items, subjects, or authors that are of particular interest to them. In some implementations, the subjects or authors of content items may be ascertained via content tags. In this manner, it is possible to ascertain a popularity of the content, a popularity of a subject of the content, or a popularity of an author of the content. Popularity of content items, subjects, or authors also may be inferred via application of an exponential decay function. For example, it may be assumed that the popularity of a particular news item will reduce exponentially over time. Data indicating a popularity of content items, subjects, or authors may be stored, for example, at a remote location.

The criteria used for prioritization also may include a popularity of various applications among a plurality of users. The popularity of the applications may be determined based, at least in part, upon user feedback from the plurality of users, user activity of the plurality of users, or both. The user feedback may be obtained from the plurality of users via the display device, similar display device(s), or other device(s). Similarly, the user activity of a plurality of users may be detected via the display device, similar display device(s), or other device(s).

A ranking algorithm used to rank a set of content items such as news articles may be implemented via a variety of algorithms. One example ranking algorithm is as follows:

R(n)=Sum(aP(currentUser)+bP(other users))/T̂decay

where

a and b are adaptive weights,

T is time in hours,

decay is a time constant (between 1 and 2), and

P=popularity

The ranking algorithm may be implemented via a machine learning algorithm, where the adaptive weights are updated periodically to reflect user feedback or activity.

As user feedback is received or user activity is detected, such as via the display device or another device, the historical information may be updated. The historical information may be stored in a memory of the display device, one or more data stores that are external to the display device, or both the memory of the display device and one or more data stores that are external to the display device. More particularly, the one or more data stores may be connected to the display device or may be remotely located. For example, such a data store may include a subscriber identification module (SIM) card or a remotely located server.

The prioritization may be performed based, at least in part, upon the historical information. In some implementations, such historical information may pertain to previously received user feedback or other activity of a user of the display device or both. Thus, the historical information may pertain to a single user of the device. In some other implementations, the historical information also may pertain to feedback or activity of one or more other users or both. For example, a display device may store historical information for each user of the display device. In some implementations, the historical information may uniquely identify each of the users. The historical information may be stored in a memory of the display device or in one or more data stores that are external to the display device or both. For example, the one or more data stores may be operatively coupled to the display device or may be remotely located, such as at a remotely located server.

In some implementations, the prioritization may be performed via a machine learning algorithm that is periodically updated with historical information pertaining to feedback received via the display device. At block 816, information pertaining to at least a portion of at least one of the sets of content generated or provided by at least one of the applications may be rendered to one or more of a plurality of regions of the second display according to a result of the prioritizing. More particularly, the information may be rendered across the entire second display. Alternatively, the rendering of the information may be performed such that each of the at least one of the applications or content types associated therewith is mapped to a different, corresponding one of the plurality of regions of the second display. The at least a portion of at least one of the sets of content may be selected for rendering based, at least in part, upon a result of the prioritizing. In addition, the information may be rendered at different points in time according to a result of the prioritizing. Moreover, information for multiple sets of content may be rendered in a physical order or configuration among the plurality of regions, where the order or configuration is selected according to a result of the prioritizing. Similarly, information pertaining to a particular set of content or portion thereof may be rendered in a particular physical order or configuration within a corresponding region according to a result of the prioritizing. Alternatively, the information for multiple sets of content may be rendered according to a mapping that has previously been established between each of the at least one of the applications (or content types associated therewith) and the one or more of the plurality of regions of the second display.

Default or user settings may indicate a particular number of content items or a maximum number of content items for which information is to be provided for a particular application or content type, and therefore a corresponding one of the plurality of regions of the second display. For example, default or user settings may indicate that information for a maximum of three content items can be provided to one of the plurality of regions of the second display. Such a setting may be applicable to all regions of the second display, or specific region(s) of the second display. In some implementations, the setting may be associated with a particular application or content type. For example, a user setting associated with an email application may establish that information for a maximum of ten emails be provided to a corresponding one of the plurality of regions of the second display. Therefore, the information also may be rendered in accordance with these default or user settings.

The information that is rendered may include status information such as an indication of receipt of an electronic mail message, text message, or phone call. In addition, the information may include metadata such as that associated with music or a video playing on the first display. The information also may include actual content such as an electronic mail message, text message, or phone message.

FIG. 10 is a diagram illustrating an example screen shot of a second display of a display device. In some implementations, the second display may include a plurality of regions 1002, 1004, 1006, 1008 and 1010. In this example, the second display includes five regions that may be separately updated. However, the second display may include any number of regions, which may be in different configurations. For example, the plurality of regions of the second display may be of the same or different sizes. Thus, each of the regions 1002, 1004, 1006, 1008, and 1010 may have corresponding dimensions, which may be defined, for example, by a width and length. As another example, the plurality of regions of the second display may have the same shape or different shapes. Each of the plurality of regions of the second display may correspond to or be mapped to a different one of a plurality of applications or content types. Conversely, each one of a plurality of applications or content types associated therewith may correspond to a different, corresponding one of the plurality of regions. Thus, a particular one of the plurality of regions may be associated with a single application or a single content type. For example, a single region may provide status updates such as sports updates and financial ticker updates.

As will be shown in further detail with reference to FIG. 10, information such as notifications, status information, or content provided by, generated by, or otherwise pertaining to a particular application may be rendered to a corresponding one of the plurality of regions. Such an application may include, for example, a phone application, a text messaging application, an electronic mail application, or a social media application. Status information may include a status of the application such as a call status. For example, the status may indicate that no new calls have been received. Notifications may indicate a change in status, such as the receipt of a new call. The notification may simply indicate the receipt of a new call. The notification also may include information indicating an identity of the individual or source to which the notification pertains, a type of source to which the notification pertains, or a category of content to which the notification pertains. For example, the notification may indicate a phone number or name associated with a missed call that was recently received via the display device. In addition, content may be provided, either instead of or in association with a notification. Such content may include, for example, a text message or electronic mail message.

In this example, the regions 1002, 1004, 1006, 1008 and 1010 are implemented via separate rows of the second display. As shown in this example, the information provided via one or more of the regions of the second display may include annunciator data 1002 such as signal strength, battery life, time, weather data, or connectivity status such as via Bluetooth or Wi-Fi. The information also may include social media or other notifications. For example, the information may include notifications of missed calls, the receipt of text messages, the receipt of electronic mail messages, or calendar notifications, as shown at region 1004. The information also may include social network feeds provided by one or more social media applications, as shown at 1006. Critical notifications such as those pertaining to the receipt of critical electronic mail messages or critical social network alerts may be rendered via a corresponding region 1008 of the second display. For example, the critical social network alerts may include updates to a social media status of a friend or contact, such as a Facebook or Twitter status. Non-critical notifications such as sports updates or financial ticker updates may be rendered via a corresponding region 1010. It is important to note that the regions shown in FIG. 10 are merely illustrative. A person having ordinary skill in the art will readily recognize that the regions can display different information than that shown in FIG. 10. For example, notifications pertaining to missed calls may be rendered to the region 1010 rather than the region 1004.

In addition, although not shown in this example, the information that is rendered via region(s) of the second display may include metadata from music or video being played on the first display or a region of the second display. Moreover, the information may include advertisements such as promotional deals, coupons, or customer loyalty information. The advertisements may be selected based, at least in part, upon user feedback or user activity that is received or otherwise detected in accordance with various implementations. For example, advertisements may be selected based, at least in part, upon usage patterns of the user. In addition, the advertisements may be selected based, at least in part, upon other contextual information such as information obtained by the sensor system, search activity, social media activity, or other triggers such as a time of day. The information obtained by the sensor system may include, for example, a position or a location of the user. In this manner, advertisements that are relevant to a context in which the display device is being used may be selected and provided to the display device.

In some implementations, a controller of the display device may obtain or determine a mapping between the regions 1002, 1004, 1006, 1008 and 1010 and corresponding applications or content types. More particularly, the controller may obtain or determine one or more of a location, size, shape, dimensions, or configuration of one or more of the regions 1002, 1004, 1006, 1008 and 1010 within the second display. In some implementations, after the regions 1002, 1004, 1006, 1008 and 1010 have been rendered, a user may choose to modify the location, size, shape, dimensions, or configuration of one or more of the regions 1002, 1004, 1006, 1008 and 1010. In these instances, user input may be received via a number of single-touch or multi-touch gestures or both, such as tap, double tap, long press, scroll, pan, flick, two-finger tap, two-finger scroll, pinch, spread and rotate by touching, swiping, or performing other gestures with respect to the region(s) of the second display. In this manner, the user may move or otherwise adjust one or more of the regions 1002, 1004, 1006, 1008 and 1010 within the second display. By moving a region within the second display, the user may move an application or content type corresponding to that region.

User feedback with respect to the information that has been rendered to the second display may be received when the user interacts with the display device. In some implementations, the user feedback may be received when the user interacts with the information that has been rendered to the second display. More particularly, user feedback may be obtained from user input, which may be received via one or more of the regions of the second display. For example, the user feedback may be detected when the user clicks or double-clicks on the information. Alternatively, the user input may be received via another input mechanism. In addition, in some other implementations, user feedback may be detected via one or more sensors. For example, a movement or rotation of the display device may be detected and interpreted as interest of the user in the information that has most recently been rendered to the second display.

Characteristics of the user interaction with the display device or the user interaction with the information provided to the second display may be tracked and recorded as historical information. More particularly, the characteristics of the user interaction pertaining to each one of a plurality of content types or applications or both may be recorded. In some implementations, this may be accomplished by recording the characteristics of the user interaction with respect to one or more of the plurality of regions of the second display in which the information has been rendered.

In some implementations, the historical information, any analysis of the historical information, or a machine learning algorithm may be stored to one or more memories that are local to the display device or one or more memories that are remotely located with respect to the display device or both. More particularly, the historical information, analysis of the historical information, or a resulting machine learning algorithm may be stored in a memory of the display device, a memory coupled to the display device, or a memory of a remotely located network device.

In some implementations, the characteristics of the user interaction may indicate whether feedback has been received with respect to the information that has been rendered to one of the plurality of regions of the second display. For example, the characteristics of the user interaction may indicate whether the user has sent a reply to a message received from another individual. Moreover, where user feedback has been received with respect to the information that has been provided, the characteristics of the user interaction also may indicate a time period that has elapsed between a time of the rendering the information and a time of receiving the user feedback. For example, the characteristics of the user interaction may indicate a time period that has elapsed between a time of the rendering the information and a time of receiving user input with respect to the rendered information. In this manner, it is possible to gauge a user's interest in a particular type of content or a particular application or both. In addition, the characteristics of the user interaction may indicate one or more of a recency with which the user feedback has been received, an amount of time spent by a user viewing the information that has been rendered to the one of the plurality of regions of the second display, a percentage of the information that has been rendered to the one of the plurality of regions of the second display that the user has read or otherwise accessed, or a depth within the information that has been rendered to the one of the plurality of regions of the second display that the user has read or otherwise accessed. For example, the characteristics of the user interaction may indicate that the user read a header of a message, but did not read the body of the message.

The characteristics of the user interactions over time also can indicate a level of user interest with respect to categories of content items within a particular type of content or associated with a particular application. Such categories of content items, like electronic mail messages, may include, but are not limited to, categories defined by a source of the content item, a type of the source of the content item, or a subject of the content item. For example, the characteristics of the user interactions may show that within electronic mail messages, the user is more interested in messages that have been received from his or her boss than those received from his or her colleagues. As another example, the characteristics of the user interactions may indicate that the user is more interested in messages received from work colleagues than those received from personal contacts.

In addition, user preferences received from the user may indicate a level of user interest in one or more of a plurality of content types or one or more of a plurality of applications or both. More particularly, the user may specify or select one or more of the plurality of content types or one or more of the plurality of applications or both to indicate those content type(s) or application(s) or both for which the user wishes to receive information. In addition, the user preferences received from the user may indicate a priority with which information associated with two or more content types or two or more applications or both should be provided. For example, the user may implicitly or explicitly associate a priority with two or more content types or two or more applications or both. Similarly, the user preferences received from the user may further indicate a level of user interest with respect to two or more categories of content items within a particular content type or associated with a particular application. For example, the user may specify, select, or otherwise indicate a priority associated with the two or more categories.

The level of user interest, as determined from user interactions or user preferences or both, may indicate priorities among two or more content types of a plurality of content types or two or more of a plurality of applications or both. The priorities may be used to select at least a subset of the plurality of content types or applications or both for which to provide information to the second display. For example, where the user is determined to be most interested in a text messaging application, an electronic mail application, and a clock application, information corresponding to these three applications may be provided to three different corresponding regions of the second display. The user may select a content type or application from the subset to view information associated with the selected content type or application, or access content items associated with the selected content type or application. For example, when the user selects one of the content types or applications such as the electronic mail application, a number of content items having a highest priority or information associated therewith may be rendered to one or more of the entire second display, a particular region of the second display, or the first display. The user also may interact with the second display or the first display to view information associated with alternative or additional content types or applications.

The level of user interest, as determined from user interactions or user preferences or both, also may enable two or more categories of a set of content items to be prioritized. More particularly, the two or more categories may be associated with a particular content type or application. For example, where a set of content items includes email messages, a first category may include email messages received from co-workers and a second category may include email messages received from friends. Once a priority of two or more categories of content within one of the sets of content has been ascertained, at least a subset of the set of content items or information associated therewith may be rendered to one of the plurality of regions of the second display. More particularly, the priority may be applied to select one or more of the two or more categories for which to render content items or information associated therewith, ascertain a physical configuration or order in which content items within the two or more categories of content or information associated therewith is to be provided within a particular region of the second display, or ascertain time(s) at which content items within the two or more categories of content or information associated therewith is to be rendered to the particular region of the second display.

The user may interact with region(s) of the second display to view or otherwise access content items or information associated therewith. For example, the user may click on a particular region of the second display to view or otherwise access content items or information associated therewith. As another example, the user may delete a particular content item or information associated therewith from the particular region of the second display, which may trigger the rendering of additional content item(s) or information associated therewith. In some implementations, upon interaction of the user with a particular region of the second display, content items or information associated therewith may be rendered within the particular region of the second display. In some other implementations, upon interaction of the user with a particular region of the second display, content items or information associated therewith may be rendered in another region of the second display, the entirety of the second display, or may be rendered to the first display. This may be accomplished by opening the corresponding application in one or more regions of the second display or opening the corresponding application in the first display. In some implementations, a zoom-out touch action or gesture by the user could explode a particular region such that the region is expanded to cover a larger area of the second display. For example, the user may explode a particular region such that it is expanded to cover the entire second display. Similarly, a zoom-in touch action or gesture by the user, such as a pinch touch action, could reduce the size of a region such that content items or other information is rendered to a smaller region of the second display.

A mapping between one or more of the plurality of regions of the second display and corresponding applications or content types may be established via various mechanisms. In some implementations, a default setting may indicate the mapping between the applications or content types and one or more of the plurality of regions of the second display. In some other implementations, user settings may establish the mapping between the applications or content types and the one or more of the plurality of regions of the second display. For example, a user may wish to receive call status information in a top region of the second display, and therefore may select the phone application to be associated with the top region of the second display. Alternatively, the correspondence between the applications or content types and the one or more of the plurality of regions of the second display may be determined dynamically according to a result of the prioritizing. For example, where a user is determined to be most interested in text messages based upon the user's prior feedback with respect to rendered information or the user's prior activity with respect to the applications or both, information pertaining to the user's text messages may be rendered to an upper-most region of the second display. More particularly, the user's prior activity with respect to the applications may indicate the frequency with which the user accesses specific applications.

FIGS. 11A and 11B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

In this example, the display device 40 includes a housing 41, a display system 30, an antenna 43, a speaker 45, an input device 48, a touch screen 615, a sensor system 715 and a microphone 46. One portion of the sensor system 710, which may be a proximity sensor, is illustrated in FIG. 11A. In some implementations, the sensor system 710 also may include one or more motion sensors, orientation sensors, or other sensors. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display system 30 may include any of a variety of displays, including a bi-stable or analog display, as described herein. In various implementations described herein, the display system 30 includes a first display and a second display as described above. For example, the first display may be a flat-panel display, such as plasma, EL, OLED, STN LCD, or TFT LCD, or a non-flat-panel display, such as a CRT or other tube device. In this example, the touch screen 615 is disposed on the first display. The second display system may be a lower-power reflective display, for example, an IMOD-based display, as described herein. The second display is not visible in FIG. 11A, because it is on the opposite side of the display device 40 from the first display and the touch screen 615.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. For example, the processor 21 (or another component of a control system) may be configured to perform, at least in part, the methods described herein. For example, the processor 21 may be configured to determine whether to control the first display or the second display according to input from the touch screen 615. This determination may be based, at least in part, on sensor data received from the sensor system 710. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a non-transitory computer-readable medium. The steps of a method or algorithm disclosed herein may be implemented in a processor-executable software module which may reside on a non-transitory computer-readable medium. Computer-readable media include both computer storage media and communication media including any medium that can be enabled to transfer a computer program from one place to another. A storage medium may be any available medium that may be accessed by a computer. By way of example, and not limitation, non-transitory computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations may be within the scope of the following claims. In some cases, the actions recited in the claims can be performed in a different order and still achieve desirable results.

What is claimed is:

1. A handheld device, comprising:
a first display;
a second display;
a processor; and
a memory, at least one of the processor or the memory being configured for:
obtaining one or more sets of content generated or provided by one or more applications;
prioritizing content at least one of within the sets of content or among the sets of content; and
rendering information pertaining to at least a portion of at least one of the sets of content generated or provided by at least one of the applications to one or more of a plurality of regions of the second display according to a result of the prioritizing such that each of the at least one of the applications or content types associated therewith is mapped to a different one of the plurality of regions of the second display;
wherein the prioritizing is performed based, at least in part, upon historical information pertaining to feedback that has been received with respect to information that has previously been rendered to at least one of the plurality of regions of the second display.

2. The handheld device of claim 1, wherein the second display is at least one of a reflective display or a touch-sensitive display.

3. The handheld device of claim 1, wherein the second display is selected from a group consisting of: a bi-stable reflective display, an analog reflective display, and a single-mirror reflective display.

4. The handheld device of claim 1, at least one of the processor or the memory being further configured for ascertaining a mapping between each of the at least one of the applications and a corresponding one of the one or more of the plurality of regions of the second display, wherein the rendering is further performed in accordance with the mapping.

5. The handheld device of claim 1, wherein the prioritizing includes performing one or more operations selected from a group consisting of: prioritizing the applications or the content types associated therewith and selecting the at least one of the applications for which to render information.

6. The handheld device of claim 1, wherein the prioritizing includes selecting or generating a mapping such that each of the at least one of the applications or content types associated therewith is mapped to a corresponding one of the plurality of regions.

7. The handheld device of claim 6, wherein selecting or generating the mapping includes ascertaining or establishing at least one of an optimal size or an optimal shape of at least one of the plurality of regions of the second display that is mapped to a corresponding one of the applications or content types associated therewith.

8. The handheld device of claim 1, wherein the prioritizing includes at least one of:
selecting at least a portion of one of the sets of content for which to render information, or
selecting a physical configuration or order in which the at least a portion of the one of the sets of content or information associated therewith is to be rendered within one of the plurality of regions of the second display.

9. The handheld device of claim 1, wherein the prioritizing includes ascertaining a priority of two or more categories of content within one of the sets of content.

10. The handheld device of claim 1, wherein the historical information indicates characteristics of the feedback that has been received with respect to the information that has previously been rendered to the at least one of the plurality of regions of the second display, wherein the characteristics indicate at least one of:
a recency with which the feedback has been received with respect to the at least one of the plurality of regions of the second display,
an amount of time that has lapsed between a first time at which the information was rendered to the at least one of the plurality of regions of the second display and a second time at which the feedback with respect to the information that has previously been rendered to the at least one of the plurality of regions of the second display has been received,
an amount of time spent viewing the information that has been rendered to the at least one of the plurality of regions of the second display,
a percentage of the information that has been rendered to the at least one of the plurality of regions of the second display that the user has read or otherwise accessed, or
a depth within the information that has been rendered to the at least one of the plurality of regions of the second display that the user has read or otherwise accessed.

11. The handheld device of claim 1, wherein the historical information indicates whether feedback has been received with respect to the information that has previously been rendered to the at least one of the plurality of regions of the second display.

12. The handheld device of claim 1, wherein the historical information is at least one of historical information stored in the memory of the handheld device or historical information pertaining to a particular user.

13. The handheld device of claim 1, at least one of the processor or the memory being further configured for:
obtaining feedback with respect to the information that has been rendered to the one or more of the plurality of regions of the second display; and
recording characteristics of the feedback such that the historical information is updated.

14. The handheld device of claim 13, wherein obtaining the feedback with respect to the information that has been rendered to the one or more of the plurality of regions of the second display includes performing at least one of: obtaining the feedback via the one or more of the plurality of regions of the second display, obtaining the feedback via one or more input mechanisms of the handheld device, or detecting the feedback via one or more sensors of the handheld device.

15. The handheld device of claim 13, wherein the characteristics of the feedback indicate at least one of:
a recency with which the feedback has been obtained with respect to one of the plurality of regions of the second display,
an amount of time that has lapsed between the rendering of the information to the one of the plurality of regions of the second display and a time that the feedback with respect to the information that has been rendered to the one of the plurality of regions of the second display has been obtained,
an amount of time spent by a user viewing the information that has been rendered to the one of the plurality of regions of the second display,
a percentage of the information that has been rendered to the one of the plurality of regions of the second display that the user has read or otherwise accessed, or
a depth within the information that has been rendered to the one of the plurality of regions of the second display that the user has read or otherwise accessed.

16. The handheld device of claim 1, wherein the prioritizing is performed via a machine learning algorithm, at least one of the processor or the memory being further configured for:
obtaining feedback with respect to the information that has been rendered to the one or more of the plurality of regions of the second display; and
updating the machine learning algorithm based, at least in part, upon characteristics of the feedback.

17. The handheld device of claim 16, wherein the characteristics of the feedback used to update the machine learning algorithm include at least one of:
whether feedback has been received with respect to the information that has been rendered to one of the plurality of regions of the second display,
a recency with which the feedback has been obtained with respect to the information that has been rendered to the one of the plurality of regions of the second display,
an amount of time that has lapsed between the rendering of the information to the one of the plurality of regions of the second display and a time that the feedback with respect to the information that has been rendered to the one of the plurality of regions of the second display has been obtained,
an amount of time spent by a user viewing the information that has been rendered to the one of the plurality of regions of the second display,
a percentage of the information that has been rendered to the one of the plurality of regions of the second display that the user has read or otherwise accessed,
or a depth within the information that has been rendered to the one of the plurality of regions of the second display that the user has read or otherwise accessed.

18. The handheld device of claim 1, wherein the prioritizing is performed, at least in part, upon user preferences.

19. The handheld device of claim 1, wherein the one or more applications are installed on at least one of the handheld device or at least one other network device that is separate from the handheld device.

20. The handheld device of claim 1,
wherein the processor is configured to communicate with the second display, the processor being configured to process image data.

21. The handheld device of claim 20, further comprising:
a driver circuit configured to send at least one signal to the second display; and
a controller configured to send at least a portion of image data to the driver circuit.

22. The handheld device of claim 20, further comprising:
an image source module configured to send the image data to the processor, wherein the image source module comprises at least one of a receiver, transceiver, or transmitter.

23. The handheld device of claim 20, further comprising:
an input device configured to receive input data and to communicate the input data to the processor.

24. A method, comprising:
obtaining one or more sets of content generated or provided by one or more applications;
prioritizing content at least one of within the sets of content or among the sets of content; and
rendering information pertaining to at least a portion of at least one of the sets of content generated or provided by at least one of the applications to one or more of a plurality of regions of a second display of a handheld device in accordance with a result of the prioritizing such that each of the at least one of the applications or content types associated therewith is mapped to a different one of the plurality of regions of the second display;
wherein the handheld device includes two or more displays including a first display and the second display;
wherein the prioritizing is performed based, at least in part, upon historical information pertaining to feedback that has been received with respect to information that has previously been rendered to at least one of the plurality of regions of the second display.

25. The method of claim 24, wherein rendering is performed by the handheld device, and wherein the obtaining and the prioritizing are performed by at least one other network device that is separate from the handheld device.

26. The method of claim 24, wherein the one or more applications are installed on at least one of: the handheld device or at least one other network device that is separate from the handheld device.

27. A non-transitory computer-readable storage medium storing thereon computer-readable instructions, comprising:
instructions for identifying one or more sets of content generated or provided by one or more applications;
instructions for prioritizing content at least one of within the sets of content or among the sets of content; and
instructions for rendering information pertaining to at least a portion of at least one of the sets of content generated or provided by at least one of the applications to one or more of a plurality of regions of a second display of a handheld device in accordance with a result of the prioritizing such that each of the at least one of the applications or content types associated therewith is mapped to a different one of the plurality of regions of the second display;
wherein the handheld device includes two or more displays including a first display and the second display;
wherein the prioritizing is performed based, at least in part, upon historical information pertaining to feedback that has been received with respect to information that has previously been rendered to at least one of the plurality of regions of the second display.

28. The non-transitory computer-readable storage medium of claim 27, further comprising:
instructions for obtaining feedback with respect to the information that has been rendered to the one or more of the plurality of regions of the second display; and
instructions for recording characteristics of the feedback such that the historical information is updated.

29. The non-transitory computer-readable storage medium of claim 27, wherein prioritizing is performed based, at least in part, upon at least one of feedback received from a plurality of users or activity of a plurality of users.

30. The non-transitory computer-readable storage medium of claim 27, wherein prioritizing is performed based, at least in part, upon at least one of a popularity of the at least a portion of at least one of the sets of content or a popularity of the at least one of the applications.
